(19) United States
(12) Patent Application Publication
(10) Pub. No.: US 2024/0173911 A1
(43) Pub. Date: May 30, 2024

(54) SYSTEMS AND METHODS FOR MANUFACTURING CURBSIDE-RECYCLABLE PRODUCTS FROM MONO-MATERIALS POLYETHYLENE FABRICS WITH POLYETHYLENE THREE-DIMENSIONALLY PRINTED FEATURES

(71) Applicant: Massachusetts Institute of Technology, Cambridge, MA (US)

(72) Inventors: Svetlana V. Boriskina, Winchester, MA (US); Volodymyr Korolovych, Boston, MA (US); Leslie Yan, Bedford, MA (US); Duo Xu, Cambridge, MA (US)

(21) Appl. No.: 18/523,845

(22) Filed: Nov. 29, 2023

Related U.S. Application Data
(60) Provisional application No. 63/385,372, filed on Nov. 29, 2022.

(51) Int. Cl. B29C 64/118; B29B 17/04; B33Y 10/00; B33Y 40/20; B33Y 70/00; B33Y 80/00; D03D 1/00; D03D 15/283; D04H 3/007; D04H 3/05; D04H 3/16; D06C 7/02

(52) U.S. Cl. CPC B29C 64/118; B29B 17/04; B33Y 10/00; B33Y 40/20; B33Y 70/00; B33Y 80/00; D03D 1/00; D03D 15/283; D04H 3/007; D04H 3/05; D04H 3/16; D06C 7/02; B29K 2023/065; D10B 2321/0211; D10B 2401/04

(57) ABSTRACT

A polyethylene (PE)-based fully-recyclable textile material and product formed by three-dimensionally printing PE structures onto a polyethylene textile is provided. The textile material can include one or more PE filaments being directly deposited onto a PE fabric via an FDM printing process to form a mono-material. The deposition of structures onto the PE fabric, which can form the substrate of the textile, can be used to enable changes to the mechanical properties of the fabric and/or create novel design aesthetics. Moreover, this material can be characterized by its ability to be thermally recycled, from which new PE-based products and materials may be manufactured. For example, the PE-based fully-recyclable textile material can be formed into a PE recyclate that can be melted and re-pelletized for formation of alternative PE-based fully recyclable textile materials. The PE-based fully recyclable textile material can be used in footwear and other wearable applications, as well as spacesuits, helmets, bulletproof vests, sweat-proof garments, racing suits, and so forth.

### CROSS REFERENCE TO RELATED APPLICATION

The present disclosure claims priority to U.S. Provisional Application No. 63/385,372, entitled “Curbside-recyclable Products from Mono-material Polyethylene Fabrics with Polyethylene 3D Printed Features and Methods Thereof,” which was filed on Nov. 29, 2022, and which is incorporated by reference herein in its entirety.

### GOVERNMENT RIGHTS

This invention was made with government support under W911NF-13-D-0001 awarded by the U.S. Army Research Office. The government has certain rights in the invention.

### FIELD

The application relates generally to systems and methods of three-dimensional (“3D”) printing onto textile substrates, and more particularly to a single polymer material approach for manufacturing recyclable products from polyethylene (PE) fabrics with PE 3D printed features.

### BACKGROUND

In 2020, over 20 billion pairs of shoes were produced by a global industry that emphasizes fast fashion volumes to meet ever-increasing worldwide demand. A consequence of the increased demand, however, has been the industry's responsibility for a staggering 1.4% of global greenhouse gas emissions. The sneaker, in particular, presents a lens through which to understand the basis of these disconcerting figures: for a standard running shoe, materials and manufacturing are responsible for 98% of its lifetime carbon footprint. That is, the manner in which sneakers are designed and produced today is unsustainable and modifications are needed to reduce the carbon footprint thereof. Further, these numbers say little about the waste engendered in this design, namely that the available data suggests that the vast majority of shoes produced each year are destined for the landfill or incineration.

The footwear industry is not oblivious to the outsized role played by materials and design in their environmental burden. In light of such extreme levels of waste, the sneaker industry has begun to embrace the concept of sneaker circularity: an ideal that would divert the waste stream back into production and recapture material otherwise lost to disposal processes. However, the numerous challenges to achieving this ideal are already evident from the design stage. For example, the amalgamous nature of the typical sneaker design can be reflected in the shoe supply chain, in which manufacturing of a standard sports sneaker may use up to 360 processing steps for assembly of 65 discrete components manufactured from more than a dozen different materials. Further, this jumble of multi-material components may be glued and stitched together in a manner that, by design, prevents disassembly for material separation and recovery through means that would preserve the quality of the recyclate.

To date, one technology that has been recognized in both literature and industry as having potential to support a shift to a circular product economy is three-dimensional (3D) printing. As an additive manufacturing process for digital design processes, 3D printing can reduce waste generated during production, while having design flexibilities and freedoms that can help condense assembly lines and reduce material usage. In this sense, 3D printing can be a powerful tool for narrowing resource loops, especially for the labor-intensive sneaker manufacturing process. 3D printing in its present form, however, is a limited solution due, at least in part, to the limited nature of the material that 3D printing supports in the textile space.

In recent years, 3D printing of polymers on textiles (3D PPOT) has been increasingly explored by academic researchers, designers, and do-it-yourself (DIY) makers with respect to footwear manufacture. The current iteration of the 3D PPOT process suffers from several shortcomings, however, that have proven difficult to overcome. For example, some existing 3D PPOT methods utilize a form of liquid additive manufacturing over a three-dimensional “drawing” bed, a process that is considerably more expensive and less accessible than fused deposition modeling (FDM) printing. Additionally, adhesion of the extruded filament to the surface of the textile has presented a challenge in the space, especially for certain conventional material (and even monomaterial) pairings, with surfaces coming apart during manufacture and/or use. Common approaches to improve adhesion include: (i) treatment of the fabric surface by chemicals, typically applied as a solution, followed up by drying after the chemical treatment prior to printing; (ii) grafting of acrylic acid onto the textile substrate and/or application of a polyurethane (PU) adhesive film by spraying or thermocompression; (iii) treating the textile surfaces with oxygen plasma techniques; and/or (iv) increasing the printing bed temperature to exceed the glass transition temperature of the textile. The former two processes can be inefficient and environmentally harmful, the third one still adds a fabrication step and increases the cost, while the fourth process often improves adhesion at the expense of lowering print quality and increased energy costs, among other issues that may exist using these common approaches.

A method of fabricating high-performance monomaterial 3D PPOTs via traditional FDM printing technology without any additional steps is still lacking, and is described in the present context for the case of all-polyethylene (PE) monomaterial 3D PPOT technology.

Accordingly, there is a need for systems and methods for manufacturing shoes that are sufficiently cost-effective while also allowing for manufacturing of shoes to use fewer materials to facilitate straightforward recycling thereof.

### SUMMARY

The present application is directed to a novel approach to textile engineering and manufacturing that includes forming a polyethylene-based mono-material textile by three-dimensionally printing polyethylene structures onto a polyethylene textile. Use of a mono-material can simplify recycling of the polyethylene-based textile by eliminating adhesives and various other compounds that deteriorate the quality of the material used to make further iterations of the textile. In some embodiments, the textile can include one or more PE filaments being directly deposited onto a PE fabric via an FDM printing process to form the mono-material. The mono-material can form an upper of a shoe and other footwear via 3D printing. The resulting material can be thermally recycled to form new PE-based products and materials for manufacture. For example, the PE-based fully-recyclable textile material of the shoe can be formed into a PE recyclate that can be melted and re-pelletized for formation of alternative PE-based fully recyclable textile materials. In addition to shoes, the PE-based fully recyclable textile material can be used in garments, as well as a variety of alternate applications, while optimizing for values of viscosity and coefficients of thermal expansion, among others, based on the context in which the textile is used.

The present disclosure allows for woven, knitted, and/or nonwoven textiles to be able to be used as the base PE textile upon which additional material can be printed. For example, a PE filament formulated using an FDM printing process can be printed on top of the base material. This PE filament can be, for example, a nonwoven textile (e.g., Tyvek), and can be used in the same context as knitted or woven, not as a separate entity. The structures formed in the process of FDM printing can be termed “PE prints” to separate them rom nonwoven textile material semantically.

One example method for forming a fully-fashioned polyethylene (PE) polymer textile is for a textile that includes: (a) at least one of one or more PE yarns that form at least one of a woven PE fabric or a knitted PE fabric; and/or (b) one or more types of PE resins that form a nonwoven PE fabric, the nonwoven fabric formed by at least one of melt-blowing or spin-bonding. The method includes combining the at least one of woven PE fabric, knitted PE fabric, and/or nonwoven PE fabric with one or more PE filaments in a three-dimensional (“3D”) printing process to fuse the one or more PE filaments into woven, knitted, or nonwoven PE fabric such that the woven, knitted, or nonwoven PE fabric and the 3D printed pattern form a mono-material.

In at least some embodiments, the combining action can include extruding the one or more PE filament fibers directly onto the at least one of woven PE fabric, knitted PE fabric, and/or nonwoven PE fabric to form the mono-material. The method can further include impregnating the at least one of woven PE fabric, knitted PE fabric, and/or nonwoven PE fabric via at least one of an initial layer or series of initial layers of melted PE filament into pores of the at least one of woven PE fabric, knitted PE fabric, and/or nonwoven PE fabric. Additionally, or alternatively, the method can further include partially melting of the at least one of woven PE fabric, knitted PE fabric, and/or nonwoven PE fabric that is in contact with the one or more PE filament fibers.

The method can also include heat setting the fully-fashioned PE polymer textile via ironing and/or high-temperature annealing. In at least some embodiments, the method can include melt-blowing and/or spin-bonding one or more types of PE resins to form the nonwoven PE fabric. Additionally, or alternatively, the method can further include weaving and/or knitting one or more PE yarns to form the at least one of the woven PE fabric and/or the knitted PE fabric. The method can include optimizing a viscosity and/or a melt flow index of the woven PE fabric, knitted PE fabric, and/or nonwoven PE fabric, and/or the one or more PE filaments, to prevent filament buckling, under-extrusion, and/or nozzle blockage during the 3D printing process. For example, the viscosity of the at least one of woven PE fabric, knitted PE fabric, and/or nonwoven PE fabric, and/or the one or more PE filaments, can be optimized to achieve a melt flow index approximately in a range from about 1 gram per 10 minutes to about 15 grams per 10 minutes.

In at least some embodiments the method can include minimizing a coefficient of thermal expansion of the at least one of woven PE fabric, knitted PE fabric, and/or nonwoven PE fabric, and/or the one or more PE filaments, to reduce warpage of the fully-fashioned PE polymer textile. For example, the coefficient of thermal expansion of the at least one of woven PE fabric, knitted PE fabric, and/or nonwoven PE fabric, and/or the one or more PE filaments, can be minimized to approximately a range from about 60 μm/m-° C. to about 150 μm/m-° C.

The method can further include setting a printing speed of the 3D printing process to approximately a range of about 10 mm/s to about 80 mm/s. In at least some embodiments, the method can include setting a nozzle-to-textile distance of the 3D printing process to approximately a range of about 0.1 mm to about 0.3 mm.

The fully-fashioned PE polymer textile can be substantially free of adhesives between the at least one of woven PE fabric, knitted PE fabric, and/or nonwoven PE fabric, and/or the one or more PE filaments. The method can further include pelletizing the PE polymer textile to form a modified one or more types of PE resins. For example, the method can further include recycling the PE polymer textile by chopping and/or grinding the mono-material into smaller pieces that form a PE recyclate, melting the PE recyclate, and re-pelletizing the PE by reintroducing the PE polymer textile to be pelletized to form a second PE polymer textile. The second PE polymer textile can be formed by way of a single recycling step. In at least some such embodiments, the method can further include decreasing a surface energy of a molten PE filament material from approximately a range of about 35 dynes/cm to about 36 dynes/cm in a solid state at approximately room temperature to approximately a range of about 25 dynes/cm to about 26 dynes/cm at about 190 degrees Celsius.

One example of a material comprises a polyethylene (PE) polymer textile that includes one or more of: (i) at least one of PE fabric woven or knitted from PE yarn or a melt-blown or spunbonded nonwoven PE textile; and (ii) PE printed pattern. The material also includes a three-dimensionally (3D) printed structure. The 3D printed structure is directly fused into the PE fabric during 3D printing to form a mono-material. In at least some embodiments, the 3D printed structure can be formed by way of fused deposition modeling (FDM) printing.

The present disclosure also provides for an article of clothing that can include the above-described material(s). The article of clothing can include, by way of example, footwear (e.g., a shoe), such as an upper section and a lower section of footwear.

A method of manufacturing a textile includes manufacturing a garment and adding one or more accessories to the garment, with the accessories include the above-described material(s) of paragraph [0018]. In at least some such embodiments, the method can further include recycling the garment and the one or more accessories, and manufacturing a second garment from the recycled garment and the one or more accessories. The manufacturing action can be performed by a different entity such that “manufacturing” can mean “causing to have manufactured.” Likewise, the recycling action can be performed by a different entity such that “recycling” can mean “causing to have recycled.” A person skilled in the art, in view of the present disclosures, will understand other actions that can be performed by other entities such that the recited actions are “caused” to happen by one party.

Examples of the garment can include a spacesuit, helmet, bulletproof vest, sweat-proof garment, racing suit, or others. In at least some embodiments, the garment can include an upper section and a lower section of footwear. In at least some such embodiments, at least the upper section can be produced by extruding melted PE filament on a PE polymer textile during printing using an FDM printer.

### BRIEF DESCRIPTION OF DRAWINGS

This disclosure will be more fully understood from the following detailed description taken in conjunction with the accompanying drawings, in which:

FIG. 1 is a schematic side view of a prior art sneaker construction having various flexible and rigid elements thereof;

FIG. 2 is a schematic illustration of a sneaker material supply chain that visualizes heterogeneity of the sneaker construction and material origin of third-, second-, and first-tier suppliers;

FIG. 3 is a schematic illustration of one embodiment of a workflow for a fabrication process of 3D printing of PE on PE fabric (“monomaterial fully-fashioned PE/PE 3D PPOT material”) of the present embodiments that includes end-of-lifecycle mechanical recycling and closing of the material cycle;

FIG. 4 is a schematic illustration of an FDM printing process used to fabricate a monomaterial fully-fashioned PE/PE 3D PPOT material of the present embodiments with hexagonal texturing and reinforcing pattern;

FIG. 5A is a perspective view of a prior art plane woven textile created from a multi-filament melt-spun high density polyethylene (HDPE) yarn on an Ashford 16″ rigid heddle loom;

FIG. 5B is a perspective view of an example embodiment of a swatch of the plane woven textile manufactured in FIG. 5A;

FIG. 5C is a perspective view of the 3D printing process being used to manufacture a monomaterial fully-fashioned 3D PPOT textile of the present embodiments of an HDPE filament on a woven HDPE textile;

FIG. 5D is a top perspective view of various examples of the monomaterial fully-fashioned 3D PPOT textiles of FIG. 5C with various 3D printed patterns formed thereon;

FIG. 6A is a top schematic view of an example embodiment of a monomaterial fully-fashioned PE/PE 3D PPOT material that can be used as an upper of a shoe;

FIG. 6B is a top perspective view of the upper of the shoe of FIG. 6A as manufactured in view of the present disclosures;

FIG. 6C is a top perspective view of several embodiments of stand-alone 3D printed PE elements that are used with the upper of FIGS. 6A-6B;

FIG. 7A is a graph that compares adhesion force measured for several types of 3D PPOTs with varying combinations of textiles and FDM filament resins;

FIG. 7B is a perspective view of a geometry of the prototyped and tested 3D PPOT structures of FIG. 7A;

FIG. 7C is a perspective view of a peeling procedure used to test the adhesion force of FIG. 7B;

FIG. 7D is a detailed top view of an example embodiment of a base PE fabric and a nonwoven HDPE textile;

FIG. 7E is a detailed top view of an example embodiment of a 3D PE/PE PPOTs and a nonwoven HDPE textile (Tyvek);

FIG. 7F is a detailed top view of an example embodiment of a base PE fabric and a technical woven low density polyethylene (LDPE) fabric;

FIG. 7G is a detailed top view of an example embodiment of a 3D PE/PE PPOTs and a technical woven LDPE fabric;

FIG. 8A is a graph illustrating prior art typical tensile curves found in prior literature comparing performance of a heterogeneous 3D PPOT comprised of a woven polyester (PET) textile with a polylactic acid (PLA) print;

FIG. 8B is a graphical illustration of measured textile curves for a monomaterial PE/PE 3D PPOT compared to the corresponding curves for a nonwoven PE textile (Tyvek) used as the base material in the PE/PE 3D PPOT construction;

FIG. 8C is a perspective view of a tensile tester used to collect the data shown in FIG. 8B;

FIG. 8D is a detailed top view of an example embodiment of an HDPE/HDPE 3D PPOT based on a nonwoven textile with a hexagonal FDM printed pattern;

FIG. 9A is a graph illustrating empirical estimates of the quality of 3D PPOT adhesion strength and warping through visual and haptic inspection of prior art of various FDM prints on various base textiles, including nylon prints on nylon woven textile;

FIG. 9B is a graph illustrating temperature dependence of the thermal expansion coefficient on PE with high and low crystallinities based on prior art literature data;

FIG. 9C is a graph illustrating temperature dependence of the specific volume of PE resins on HDPE and LDPE based on prior art literature data;

FIG. 10A is a schematic top view of a source of under-extrusion of the prior art having buckling in comparatively soft PE filaments;

FIG. 10B is a schematic top view of a source of under-extrusion of the prior art having grinding found in relatively stiff PE filaments;

FIG. 11A is a schematic perspective view of a Discovery Hybrid Rheometer HR-20 instrument with an environmental test chamber used to measure values of dynamic viscosity;

FIG. 11B is a graph illustrating dynamic viscosity measurements of different PE resins measured by the instrument in FIG. 11A;

FIG. 12A is a top perspective view of a comparison of 3D printed samples with under-extrusion (linear low density polyethylene (LLDPE), top) and without under-extrusion (Blend, bottom); and

FIG. 12B is a front perspective view of a comparison between sample exhibiting warpage (medium density polyethylene (MDPE), top) and without warpage (Blend, bottom).

### DETAILED DESCRIPTION

Certain exemplary embodiments will now be described to provide an overall understanding of the principles of the structure, function, manufacture, and use of the devices and methods disclosed herein. This includes in the description and claims provided for herein. Further, one or more examples of these embodiments are illustrated in the accompanying drawings. Those skilled in the art will understand that the devices and methods specifically described herein and illustrated in the accompanying drawings are non-limiting exemplary embodiments and that the scope of the present disclosure is defined solely by the claims. The features illustrated or described in connection with one exemplary embodiment may be combined with the features of other embodiments. Such modifications and variations are intended to be included within the scope of the present disclosure. The present disclosure includes references to non-limiting, exemplary materials (e.g., fibers and yarns) formulated in conjunction with the disclosures and teachings herein, that were used in conjunction with arriving at the present disclosures. A person skilled in the art, in view of the present disclosures, will understand that these materials are non-limiting examples and have properties as provided for in, and/or derivable from, the present disclosures.

The present disclosure is generally directed to devices and methods for forming a polyethylene (PE)-based mono-material by three-dimensionally printing polyethylene structures onto a polyethylene textile. This textile can include melt-spun monofilament or multifilament fibers, or yarns made from polyethylene polymer, which may be woven, knitted, melt-blown, or spun bond to form the fabric structure. In the present disclosures, the focus is not on any specific function or topology of the base textile, with it being PE-based, and thus, prior art textiles and/or any other PE-based textile (e.g., Tyvek) can form a base for monomaterial PE/PE 3D PPOT, a PE 3D PPOT also being described as a fully-fashioned PE polymer textile. The printed structures, which can be formed by at least one layer of deposited polyethylene filament, may include a discrete element or a series of elements. A combination of these structures may also be printed in the production of an article of the mono-material. In some embodiments, the printed structures may include voids that leave regions of the fabric exposed.

The deposition of structures onto the PE fabric substrate can be used to enable changes to the mechanical properties of the fabric. These properties may include stiffness, feel to skin, shape retention, impact resistance, cushioning, drapability, durability, breaking strength, abrasion resistance, moisture resistance, and air permeability. They may also be used to produce novel aesthetics, particularly those that may be otherwise difficult to achieve through traditional manufacturing means. Different regions of the fabric may contain different types of printed structures, thus producing a mono-material with zones of variable physical properties and/or aesthetics.

### PRIOR ART

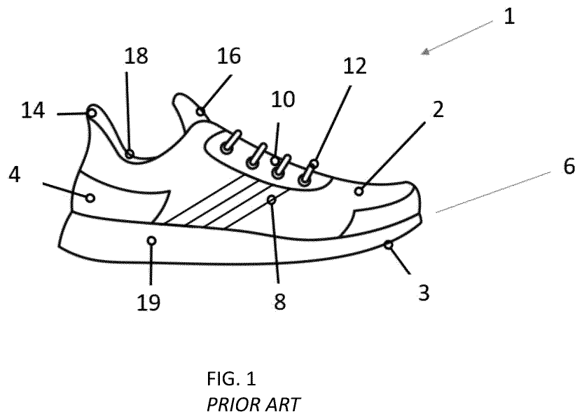

Modern sneakers can be found in an enormous array of styles geared for a variety of applications, whether athletic, lifestyle, or a combination of both. With such diversity in their manufacture, it is difficult to define a prototypical sneaker design, though many sneakers do share similarities in fundamental construction. FIG. 1 illustrates an example of a prior art schematic of an athletic shoe or sneaker 1. As shown, the sneaker 1 can be composed of two main functional units: an upper 2 that includes the top portion of the shoe that covers the foot and a sole, or outsole, 3 that includes the lower portion of the shoe that is underneath the foot. Other portions of the sneaker 1 can include a heel counter 4 and a toe box 6, which are internal components that can create select areas of stiffness for protection and foot support. Additional forms of reinforcements in the sneaker 1 can be added in other parts of the upper 2, such as saddle overlays 8 over the sides of the foot and eyelets 10 to hold laces 12. Certain sections like the collar 14 and the tongue 16 can be padded for comfort, and lining or sockliner 18 can play an important role for moisture wicking.

From a design standpoint, the upper 2 tends to be significantly more intricate than the sole 3, serving as the central canvas for aesthetic contributions while also fulfilling multiple functional requirements. The upper 2 is also usually more flexible than the sole 3 at least because the upper 2 wraps over the top of the foot, also covering the sides of the foot, while the sole 3 only sits beneath the foot. Typically, these requirements differ between regions of the upper 2, depending on needs for distinct areas of the foot, manifesting in an upper with property gradients. For example, a standard upper 2 may be formed from a large piece (or multiple pattern pieces) of a single flexible material to which a myriad of separate internal and external components are joined together to form the final upper 2 unit.

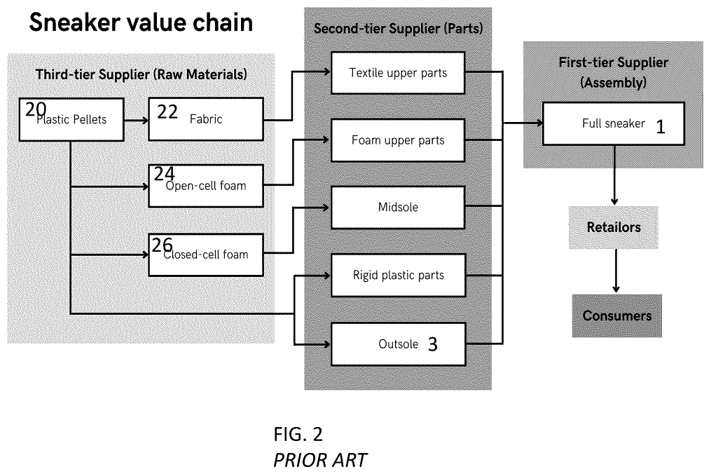

To meet the wide range of functional needs, the upper 2 can be composed of a number of different material elements of varying levels of stiffness, such as leather, ethylene vinyl acetate (EVA), and nylon. These material elements may utilize different joining methods, such as adhesives or stitching, to ensure durability. A diversity of material elements and the manner in which they are secured to the upper 2, or fabric article necessitates a multi-step production process that can lead to increased costs, labor needs, material and resource consumption, production time, and equipment needs. FIG. 2 provides a summary of the steps in the traditional footwear supply chain according to supplier tiers and assembly stages. As shown, a third tier supplier can use plastic pellets 20 to manufacture fabric 22, open-cell-foam 24, and/or closed cell foam 26. These materials can be used by a second-tier supplier to make parts of the shoe. For example, as shown, the fabric 22 can be used to manufacture textile parts of the upper 2, the open-cell foam 24 can be used to manufacture foam parts of the upper 2, and the closed cell-foam 26 can be used to make the midsole 19. In some embodiments, the plastic pellets 20 can be used to form rigid plastic parts and/or the outsole 3. Each of the second-tier suppler parts can then be used by the first-tier supplier to form the sneaker 1, which is then sold to retailers and eventually consumers (or directly sold to consumers without retailer involvement).

Conventional sneaker manufacturing techniques are not well suited for recycling due, at least in part, to the multi-material construction not being designed for disassembly. This can make it difficult to separate and recover materials from the fabric article in a manner that enables recycling and/or reuse of the material(s) for high-value applications. Moreover, disposal of such multi-material articles by landfill or incineration can impose environmental detriment, part of which comes from the resource intensity of the disposal process itself. In recent years, brands have made attempts to practice circular design techniques through their footwear products. An example of these techniques can include The Loop sneaker, a beta-released performance running shoe has been made entirely from thermoplastic polyurethane (TPU), thereby capitalizing on a mono-material design approach. Conventionally, TPU has been engineered into various foam, textile, and rigid components to create a sneaker that can be fully recyclable as a single unit. However, unlike PE, TPU is not widely accepted in municipal recycling programs, which complicates creating a closed-loop material cycle. Furthermore, unlike PE, TPU does not allow for engineering thermal conductivity and infrared absorptance/transmittance properties, limiting overall thermoregulatory performance of the final 3D PPOT product. Still further, TPU is more expensive than conventional plastics (especially PE), and some grades of TPU have a relatively short shelf life.

### Mono-Material Fabrication Technique for Textile Manufacture

A mono-material approach of the present embodiments based on re-engineering of common polyethylene is uniquely suited to address fabrication and circularity challenges in the footwear space. Polyethylene (PE) is one of the most widely used commodity plastics. It provides versatility, affordability, manufacturability, and excellent engineering characteristics, such as good chemical and wear resistance. Found in applications ranging from food packaging to shopping bags to toys, polyethylene (PE) is the most widely-used family of plastics in the world today. Despite being among the cheapest commodity plastics available, polyethylene possesses many advantageous engineering characteristics such as good corrosion and durability. Moreover, while not commonly utilized for textiles or wearable applications, polyethylene offers significant potential as a performance fabric due to its washability, durability, and lightweightedness. Further still, PE fabric can also be engineered to be moisture-wicking and thermally cooling.

The versatility of PE can be attributed in part to its thermoplastic nature, which means that it softens and/or melts when heated for easy processing, as well as its linear-chain chemical structure with the carbon backbone. This suggests that thermoplastics can also be re-melted for reuse, and can therefore be mechanically recyclable. In fact, unlike TPU, PE is one of the most commonly recycled plastics, with HDPE being one of the few numbered plastics broadly accepted in curbside recycling programs in the United States. PE can further distinguish from other thermoplastics, such as TPU, due to the vast range of PE resin types that can be synthesized. While all PE-based resins can share the same ethylene monomer (C₂H₄), they can be differentiated by their molecular structure. The side-branching of the polymer chains in low density polyethylene (LDPE) can produce a plastic that is softer and more flexible than high density polyethylene (HDPE), which can be more rigid and durable owing to its regular structure of densely-packed linear polymer chains. It will be appreciated that ultra-high weight molecular polyethylene (UHWMPE) has particularly long polymer chains, resulting in poor processability but superior performance when it comes to properties such as impact strength and abrasion resistance.

Unlike many other types of plastics, different types of PE resins can be compatible when mixed, allowing for the creation of miscible blends that optimize the advantages of different constituent PE types. The tailorable performance of PE blends presents an opportunity for the design of mono-PE products that avoid the need for separation and disassembly processes without compromising on performance. For example, in embodiments in which PE is mixed with other types of plastic or non-plastic materials during recycling, the resulting recyclate typically exhibits lower inferior mechanical properties, preventing the use of the recyclate for higher-value applications. Use of a mono-material approach allows for circumvention of these deficiencies.

The growth potential for bio-based PE presents a model through which PE can be obtained from renewable sources. As an example, HDPE can undergo several cycles of mechanical recycling without notable detriment to performance. For example, polyethylene can be mechanically recycled, including into new polyethylene-based products. Polyethylene stands out even among other thermoplastics as one of the few numbered recycling plastics typically accepted by curbside programs and recovered at a relatively high percentage rate. This presents an environmental advantage by preventing the consumption of resources to produce virgin PE resin and to dispose of the original PE product. Curbside recyclability of polyethylene can offer a unique opportunity to utilize municipal recycling programs as a resource recovery pathway for a mono-PE sneaker. Such a pathway can be readily implemented without the need to build new infrastructure.

Fused deposition modeling (FDM), a popular form of three-dimensional (3D) printing, has been widely recognized in both literature and industry as a technology with significant potential to support a shift to a circular product economy. As an additive manufacturing process for digital design processes, 3D printing reduces waste generated during production. Moreover, the design flexibilities and freedoms afforded by the manufacturing technology can help condense assembly lines and reduce material usage. In this sense, 3D printing can be a powerful tool for narrowing resource loops, especially for the labor-intensive sneaker manufacturing process.

With the elimination of specific toolings in favor of digital design files, 3D printing can open possibilities for distributed manufacturing, in which production is performed across a network of flexible, small-scale units that serve their local region. A value chain that incorporates a distributed additive manufacturing network can be a promising solution to alleviate the impact of plastic waste import bans on a potential circular sneaker economy. Part production, whether for a new generation of sneakers or other 3D-printed products, can occur in the same locality as sneaker recycling, side-stepping any regulatory uncertainties about directing recycled sneaker waste back to manufacturing facilities.

Many traditional sneaker designs include rigid components that can be integrated or attached to a textile upper 2, oftentimes with adhesive. Some non-limiting examples of such components can include the heel counter 4, the toe box 6, the eyelets 10, and so forth. Moreover, these rigid components may also be used in more novel sneaker constructions, such as a shoe with rigid side panels for adjustable support. Assembling these multi-material components is oftentimes a labor-intensive, manual process. Instead, for many wearable applications, it is desirable to attach directly rigid components or reinforcing structures to a fabric article for functional or aesthetic purposes. For example, textile-based footwear, and specifically, the upper 2 of the shoe 1, can extend across many distinct areas of the foot that use differing levels of support and comfort. Additionally, given the visibility of the upper 2 of the shoe 1 during wear, stylistic elements can be often added to the upper 2 for design purposes. For this reason, the architecture of the upper 2 can vary regionally to accommodate the different functional properties.

A mono-material 3D PPOT technology of the present embodiments can enable achieving much stronger adhesion between the 3D printed layer and the base textile, while maintaining a full mechanical recyclability of a composite product created therefrom. For example, mono-PE 3D PPOT of the present embodiments can present the opportunity to explore innovative design possibilities for functionality and aesthetics of the upper 2 of the shoe 1. With ownership of 3D printers growing increasingly common among home users and hobbyists, as well as the commercial availability of HDPE printing filament, a mono-PE product, e.g., a sneaker, can be designed for customizability by its owner, allowing for a stronger user-product relationship that can prevent premature disposal. From a functionality standpoint, DIY-repair can also be performed with at-home 3D printing, extending the useful life of the product.

These issues with PE can be avoided when printing on PE fabric. For example, the 3D PPOT techniques of the present embodiments can present new design opportunities by allowing for the selective deposition of harder or stiffer polymeric structures onto a fabric surface without needing to compromise drape and free movement, depending on the structures printed. If proper interfacial bonding can be achieved between the fabric and printed layers, the need for adhesives that can pose a contamination risk to the recyclate can be substantially eliminated. A person skilled in the art will recognize that use of the term “substantially,” such as “substantially eliminated” or “substantially free of” for the purposes of this disclosure can refer to an amount of adhesive present in the textile that is less than about 5 wt % of the textile, less than 1 wt % of the textile, less than 0.5 wt % of the textile, less than 0.25 wt % of the textile, less than 0.1 wt % of the textile, or 0 wt % of the textile. In at least some embodiments of the present disclosure, adhesives comprise 0% of the 3D PPOT product.

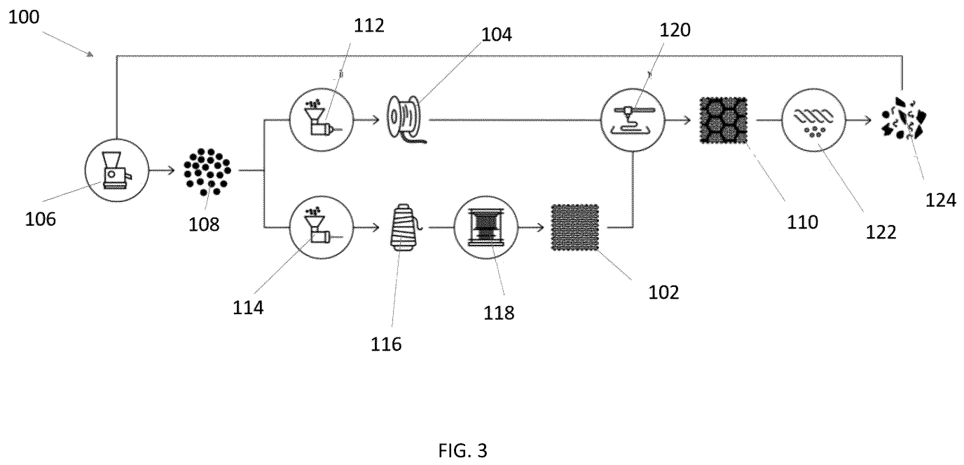

FIG. 3 illustrates a schematic of an example embodiment of a mono-material 3D PPOT fabrication pipeline 100 that includes 3D printing of PE on PE fabric of the present embodiments. The mono-material 3D PPOT fabrication pipeline 100 can include creation of both a fabric 102 and an FDM printer filament 104 from chemically identical resins, though it will be appreciated that, in some embodiments, the resins can differ by macromolecule configuration and/or molecular weight. After the PE fabric 102 and the FDM printer filament 104 are created, a monomaterial fully-fashioned PE/PE 3D PPOT textile (“textile”) or “mono-material textile”) 110 can be prototyped via an FDM 3D printing process 120. As shown, the 3D PPOT fabrication pipeline 100 can begin with pelletization process 106 of a PE mono-material to form a PE resin 108, an action referred to as pelletizing. The PE resin 108 can be used in yarn-melt spinning 112 to form the PE filament 104 and a filament extrusion process 114 to generate a PE yarn 116. The PE yarn 116 can form the PE fabric 102 via textile fabrication methods 118. It will be appreciated that the PE filament 104 utilized for 3D printing may be composed of polyethylene polymer of any density, including blends of different densities of polyethylene, which can be deposited directly onto the PE fabric substrate 102 during the 3D printing process. The action of pelletizing an existing textile, like the textile 110, can result in formation of one or more types of PE resins, like the PE resin 108. The PE resin(s) can be of a same or different configuration, and more generally can be described as having been modified, even if in the same configuration (e.g., chemical composition), by virtue of having been pelletized. That is, pelletization may result in the PE resin(s) still being of the same formulation, but may still be described as having been modified. In at least some instances, nevertheless, pelletization may result in different formulations or the like, as understood by a person skilled in the art, in view of the present disclosures.

Another aspect of the present embodiments relates to the process of manufacturing the mono-material. The manufacturing process can be performed with the use of a three-dimensional fused-deposition modeling (FDM) printer. For example, in some embodiments, the PE fabric 102 and the PE filament 104 can be combined in a 3D printing method, e.g., the FDM 3D printing process 120, to prototype the textile 110 that is composed of a PE fabric with 3D PE structures. During the FDM 3D printing process 120, the PE fabric 102, which can be used as a substrate, can be positioned over a build plate of the three-dimensional printer and subsequently secured to the build place using mechanical attachments, such as high-temperature pressure-sensitive adhesive, clamps, or magnets, to ensure accurate printing of the PE structures, as discussed in greater detail below. In some embodiments, the PE fabric 102, when being utilized as the printing substrate, may require pre-shrinking to prevent heat-induced shrinking of the fabric during the printing process. This pre-shrinking may be performed by applying heat to the fabric, such as with a standard clothes iron or steam.

An exception to the use of mechanical attachment of the fabric to the printer bed may arise for cases in which movement of the fabric during the printing process can be desired to produce certain effects in the resulting mono-material. For instance, printable structures can be designed such that the PE fabric substrate 102 may be pulled upwards into or around the structure, producing a mono-material in which the three-dimensional aspect is realized in both the printed structures and the shape of the fabric substrate 102. This phenomenon can have notable applications for the production of a mono-material footwear upper. Given the curvature of the foot, certain regions of the footwear upper 2 may use three-dimensional stability of a curved form. This can be achieved in the mono-material footwear upper article by forming the PE fabric 102 during the printing process.

At the end of the product lifecycle, the textile 110 can undergo mechanical recycling 122 to form a PE recyclate 124 that closes the material cycle. For example, this mono-material can be characterized by its ability to be mechanically recycled given the thermoplastic nature of polyethylene. This mechanical recycling process may include a series of steps that include chopping or grinding the mono-material into smaller pieces that form a polyethylene recyclate 124, melting the PE recyclate, then re-pelletizing the PE by reintroducing into the pelletization process 106. The use of mono-material can yield the advantage of easier recyclability for recovery of polyethylene for remanufacture without necessitating design for disassembly of the printed structures from the fabric, which can compromise the adhesion of the structures to the fabric, or necessitating use of adhesives, which could compromise the quality of the resulting PE recyclate. In the embodiment of a footwear upper, which is typically subject to rigorous wear conditions, this advantage is of particular interest.

The superior adhesion of the monomaterial fully-fashioned textiles 110 of the present embodiments can be achieved between the above-described PE-based textiles, e.g., PE fabrics 102, and PE-based filaments 104 to produce high-quality PE prints via FDM printing, which has traditionally been challenging. While HDPE filament 104 is readily available, a person skilled in the art will recognize that PE is not traditionally used for 3D printing at least because it adheres poorly to conventional 3D printing build surfaces, and experiences considerable shrinkage when cooling. PE is not traditionally used for 3D printing due, at least in part, to the poor adherence of HDPE to conventional 3D printing build surfaces, and considerable shrinkage when cooling. Moreover, PE is generally synthesized from petroleum that is extracted from the earth via processes that harm the environment, and its low cost of production can render PE products disposable. Poor quality of 3D printed PE structures can be ascribed to the high melt viscosity and high thermal contraction of polymer during the solidification and cooling processes, which are exhibited by many linear-chain PE resins with large molecular weight, such as linear low density polyethylene (LLDPE) and high density polyethylene (HDPE). This can lead to defects associated with under-extrusion and warpage of material. High intrinsic melt viscosity of linear PE resins can also cause blockage of a nozzle 170 of the extruder 132. Although under-extrusion and nozzle blockage can be resolved by switching to a nozzle with a larger diameter, the effects on the dimensional accuracy of prints can be detrimental if implemented. These issues can be avoided when printing on PE fabric, as described with respect to the manufacture of the textiles 110 of present embodiments, which can promote excellent adhesion between the fabric 102 and the print, and promote development of shrinkage-free PE resin blends optimized for FDM 3D printing.

In some embodiments, the textile 110 may be used to form a PE textile-based shoe upper containing printed structures that includes discrete components to support specific areas of the foot (i.e., heel counter 4, toe cap 6) and enable shoe functionality, as well as three-dimensional printed patterns that reinforce specified regions of the shoe upper. In such embodiments, the mono-material can be capable of meeting the numerous functional requirements of a shoe upper that may otherwise be met by a multitude of different materials and components. As a result, the mono-material textile 110 can offer the benefit of reducing time, equipment, and resources needed to manufacture a shoe upper. Moreover, greater customizability of the footwear upper can enable modification of the design of the three-dimensional printed structures without needing to significantly change the printing setup. The quality of PE 3D prints, and thus the overall quality of PE/PE 3D PPOTs textiles 110, especially those having thick and/or large-area printed elements, can be improved by (i) optimizing the polymer viscosity and (ii) reducing the thermal expansion coefficient at temperatures around the melting point of the FDM filament material.

In some embodiments, the 3D PE structures printed on the mono-material may be designed through digital means, such as with a computer-aided drawing software, then converted to G-code and transmitted to the 3D printer to be printed onto the PE fabric 102 as a series of PE filament layers. Moreover, during the printing process, an initial layer or series of initial layers of melted PE filament can be directly fused to the PE fabric by impregnating the porous PE fabric, yarns, or fibers, or by a partial melting of the PE fabric, yarns, or fibers that are in contact with the heated filament. This process can benefit from the low glass transition temperature of PE resins, sometimes referred to as very low glass transition temperature of PE resins, which is approximately in the range of about −50 degrees Celsius and about −80 degrees Celsius, depending on the molecular weight. This can ensure that even an unheated printer bed can allow for high chain mobility and fusion between the FDM print and the base textile.

By manufacturing the textile 110 of the present embodiments from a single plastic type, separation and disassembly processes are not required to recover the polyethylene material. Rather, the recycling of both the fabric and the printed elements of the mono-material may occur in one recycling step. Moreover, in view of the single-material construction of the mono-material textile, the recovered polyethylene may be of sufficient purity and quality to be used in the manufacture of new polyethylene products. One such polyethylene product may be a new embodiment of the mono-material, in which the recycled polyethylene is used to manufacture new fibers or yarns for the PE textile and/or new PE filament for the 3D printed structures. Reuse of the polyethylene plastic for new products can reduce the environmental footprint of the product in comparison to a product manufactured from virgin plastic, as well as reduces the environmental footprint incurred from disposal processes.

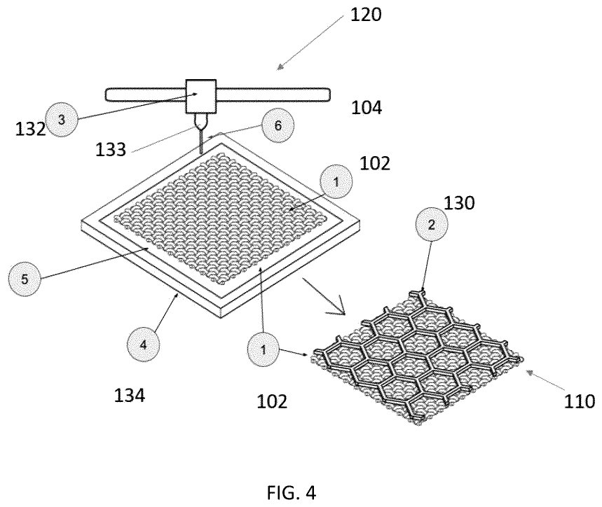

FIG. 4 illustrates a non-limiting example embodiment of the FDM printing process 120 that can be used to fabricate the monomaterial fully-fashioned PE/PE 3D PPOT textile 110. FDM printing can be characterized by depositing a molten thermoplastic polymer layer-by-layer onto a building platform, 3D printer bed, and/or build plate 134 as known to one skilled in the art. The textile 110 can include a hexagonal 3D texturing and reinforcing pattern 130 formed on a surface of the PE fabric 102 to improve its tensile and compression strength, as well as to improve cushioning and abrasion resistance. The textile 110 can be printed using an extruder 132 of the 3D printing process 120 to extrude the PE filament 104 onto a 3D printer bed 134. An adhesive, e.g., a pressure sensitive adhesive 136, can be added as a means for mechanical attachment of the PE fabric 110 to the 3D printer bed 134 to improve attachment therebetween, and in at least some instances that can be detached after printing process completion. A person skilled in the art will appreciate the functions, operations, and details of a FDM 3D printing process, and thus a detailed discussion of the principles of such a process, beyond the details discussed below, are omitted herein for the sake of brevity.

In some embodiments, a nozzle 133 of the extruder 132 of the 3D printer may be heated to a temperature that is sufficient to melt and enable free extrusion of the polyethylene filament without producing heat-induced functional or aesthetic defects to the polyethylene fabric, as can occur if the temperature is set too high. An example of an appropriate approximate nozzle temperature range can be from about 180 degrees Celsius to about 220 degrees Celsius. The printer bed 134 may also be heated to promote adhesion of the PE filament to the PE fabric 102. In some embodiments, the temperature of the printing bed can be set to a setpoint above the glass transition temperature of the textile 110, e.g., approximately in the range between about room temperature and about 70 degrees Celsius. In some embodiments, a temperature of the printer bed 134 may be approximately in the range of about 50 degrees Celsius to about 80 degrees Celsius.

3D printing these rigid components onto the textile of the upper 2 may condense part production and attachment into a single step that, if proper interfacial bonding can be achieved between the PE fabric 102 and printed layers, can eliminate the need for adhesives that can pose a contamination risk to the recyclate. The direct deposition of the filament onto the fabric can also prevent issues that can arise when heat-bonding two plastic materials with a similar melting temperature range. Yet, unlike 3D PPOT practiced with dissimilar materials, printing polyethylene filament 104 on polyethylene fabric 102 does not mandate disassembly of the rigid structures from the upper 2 for material recovery from the sneaker 1. As previously discussed, mono-PE 3D PPOT can present the opportunity to explore innovative design possibilities for functionality and aesthetics otherwise not feasible with traditional manufacturing methods, and without compromising recyclability. This includes easier customizability of the design of a sneaker upper 2, which may promote greater performance, and thus utilization of the resulting shoe. With ownership of 3D printers growing increasingly common among home users and hobbyists, as well as the commercial availability of HDPE printing filament 104, as discussed above, a mono-PE sneaker can even be designed for customizability by its owner, allowing for a stronger user-product relationship that may prevent premature disposal. From a functionality standpoint, DIY-repair of the sneaker upper can also be performed with at-home 3D printing, which can extend the useful life of the shoe.

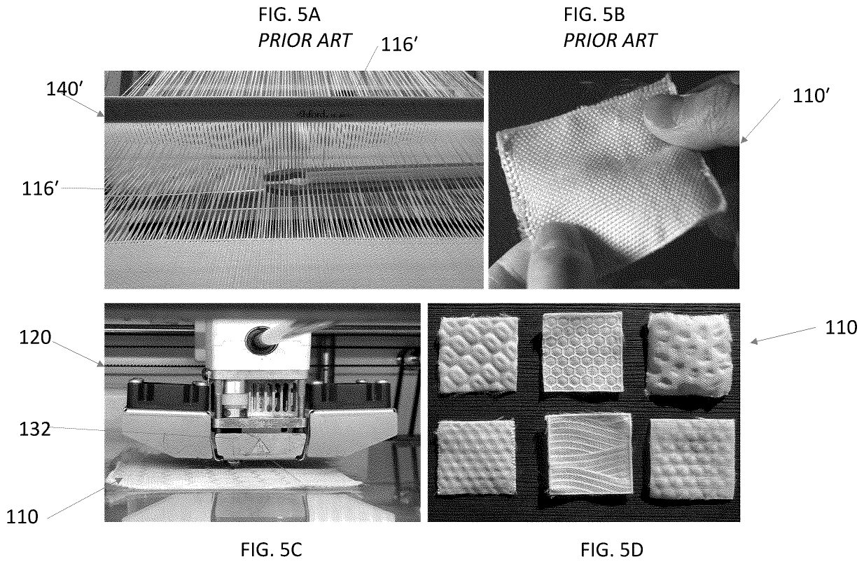

FIGS. 5A-5D illustrate an example embodiment of a prior art textile 110′ manufactured from a multi-filament melt-spun HDPE yarn on a table top loom 140′. As shown in FIG. 5A, the woven textile 110′ can be formed from HDPE using an Ashford 16″ rigid heddle loom 140′. A swatch of the textile 110′ is shown in greater detail in FIG. 5B.

FIGS. 5C-5D illustrate an example embodiment of the monomaterial fully-fashioned PE/PE 3D PPOT textile 110 of the present embodiments manufactured via the 3D printing process 120. As shown in FIG. 5C, and discussed above in FIG. 3, the FDM process can include 3D printing of an HDPE filament 104 on a woven HDPE textile via textile fabrication 118 to form the PE fabric 102, with the filament and fabric making up the textile 110. In some embodiments, the woven HDPE fabric can be heat-set by ironing prior to printing and mounted on a double-sided, thermally stable tape to secure its position during the printing process 120. In other embodiments, heat-setting of the base textile during the FDM printing process can be used to create a pre-designed 3D topography of the PE/PE 3D PPOT textile 110, as shown in some examples in FIG. 5D.

The resulting designs of the monomaterial fully-fashioned PE/PE 3D PPOT textile 110 can have various 3D printed patterns created on the woven PE fabric 102, some examples of which are shown in FIG. 5D. The variety in printed patterns and overall 3D topography of the surface can be created, for example, by changing the parameters of the FDM printing process 120 to adjust the shape of the corresponding 3D printed PE structure 130.

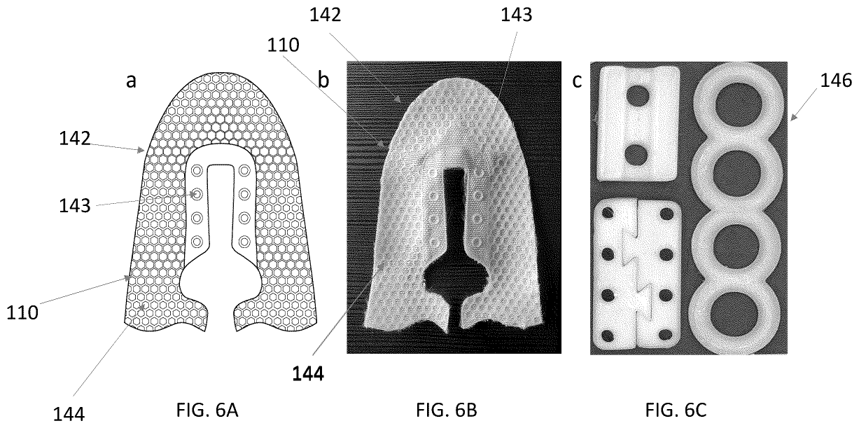

FIGS. 6A-6C illustrate an example embodiment of a monomaterial fully-fashioned PE/PE 3D PPOT material 110 of the material that can be used as an upper 142 of the embodiments, which is designed and prototyped via the PE/PE 3D PPOT technology. As shown in FIGS. 6A-6B, the upper 142 can include a single or unitary piece of the PE/PE 3D PPOT material 110 having at least eyelets 143 and overlays 144 formed thereon. The upper 142 can be used with a number of stand-alone 3D printed PE elements 146 that can be added to an overall shoe construction without compromising its recyclability. Some non-limiting examples of such elements 146 can include shoelace lockers (such as those provided for in FIG. 6C), buttons, zippers, buckles, decorative elements, company logos, and so forth, which can be recycled with the sneaker without separation. In some embodiments, designs of such elements can be created with UltiMaker Cura 3D printing software and prototyped on UltiMaker 2+using nozzle temperature of 190 degrees Celsius, nozzle diameter of 0.4 mm, printing speed (infill) of 20 mm/s, wall speed of 10 mm/min, and build plate adhesion type “brim,” though it will be appreciated that these parameters are merely exemplary and one or more of these parameters can be adjusted as needed. In some embodiments, the printing speed can be set in approximately a range of about 10 mm/s to about 80 mm/s, or approximately a range of about 20 mm/s to about 45 mm/s. A nozzle-to-textile distance can be set in approximately a range of about 0.1 mm to about 0.3 mm.

While the textile 110 of the present embodiments is discussed with respect to formation of a shoe upper, the textile 110 can be used in spacesuits, helmets, bulletproof vests (in lieu of, or in addition to, Kevlar), sweat-proof garments, racing suits, and so forth. The composition of the PE materials used to make the textile 110 can be varied, for example, based on its intended use. For instance, proportions of the PE materials in the blends that form the shoe upper can differ from the textile 110 in a bulletproof vest, with the textile 110 in the bulletproof vest having a higher concentration of HDPE or some percentage of UHMWPE resin added to promote stronger intermolecular forces between molecules of the textile 110, and thus higher tensile, impact-, and abrasion-resistance properties.

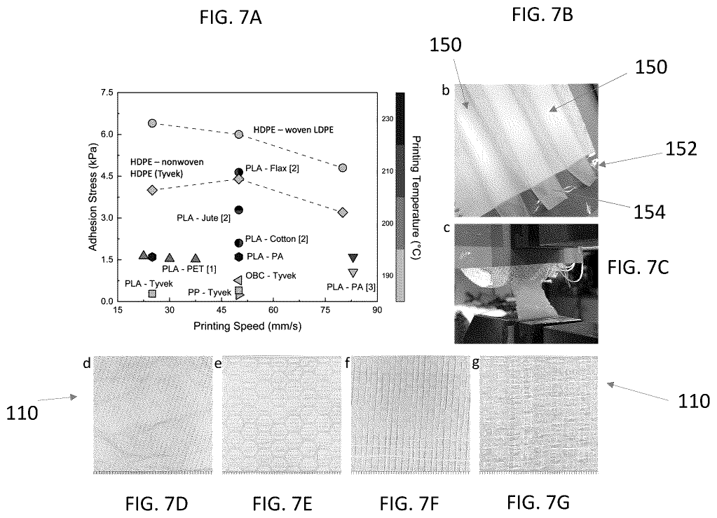

FIG. 7A is a graph that compares adhesion force measured for several types of 3D PPOTs with varying combinations of textiles and FDM filament resins. For example, the graph illustrates a correlation between adhesion stress (in kPa) and printing speed (in mm/s) for various material combinations of an FDM filament and a textile. As shown, the monomaterial PE/PE PPOTs of the present embodiments can exhibit superior performance as compared to other types of previously explored bi-material PPOTs. For this test, specimens can be prepared by depositing molten filament onto the fabric during the FDM process, with contact area measuring about 150 mm by about 25 mm. The results of testing in FIG. 7A demonstrate that higher adhesion force can be achieved in PE/PE 3D PPOTs than in any other combination of materials, even when the printing speed is higher and the nozzle temperature is lower, which translates into higher throughput and lower energy cost of the PE/PE 3D PPOT manufacturing process without compromising the material quality.

In some embodiments, a substrate 152 can be applied to part of the fabric layer 150 such that there is an additional 50 mm of material not adhered 154 to the fabric, as shown in FIG. 7B. The unadhered section 154 can then be loaded into the grips of a controlled tensile testing machine, such as an SS-EN ISO 11339 machine. The testing process can include applying load until the adhesive bond fails, and the force required to break the adhesive bond is normalized with respect to the adhesion area as adhesion stress, as shown in FIG. 7C.

In at least some embodiments, two types of PE textiles can be used to fabricate monomaterial 3D PPOTs of the present embodiments—a nonwoven Tyvek material, as shown in FIGS. 7D and 7E, and a woven industrial LDPE textile, as shown in FIGS. 7F and 7G. It can be observed that the monomaterial fully-fashioned PE/PE 3D PPOT textile 110 can exhibit superior performance to other types of previously explored bi-material PPOTs, and can be printed at low temperatures and high printing speeds, thus improving the process efficiency and reducing the energy costs.

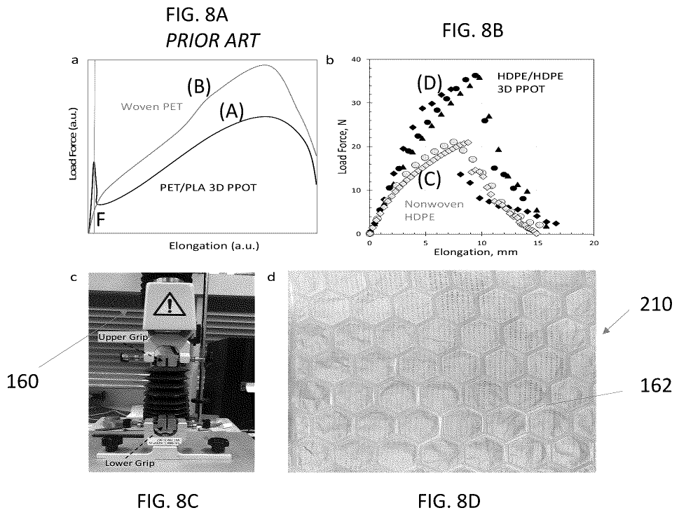

Excellent adhesion properties of the PE/PE 3D PPOT textiles 110 of the present embodiments can also translate into improved tensile properties. For example, FIG. 8A schematically illustrates the tensile strain-stress curve of a prior art heterogeneous bi-material 3D PPOT with characteristic properties exhibited, e.g., by previously studied PET/PLA 3D PPOT, comprised of a woven polyester (PET) textile (B) with a PLA 3D printed pattern (A). Characteristic properties typically exhibited by heterogeneous 3D PPOTs include (i) a clearly visible point on the curve corresponding to the failure of a 3D print, and (ii) a reduced tensile strength of a composite material relative to a base woven textile. As shown, the tensile curves of the heterogeneous 3D PPOTs can reveal two distinct parts: (i) at low strains below a PLA print failure point F, 3D PPOT exhibits larger Young's modulus; followed by (ii) a sharp drop of stress once the print fails and the remainder of the curve resembling that of a bare textile, but with reduced tensile strength. In some embodiments, surface treatment processes, e.g., oxygen plasma treatment, can improve 3D PPOT adhesion by raising the surface energy of a textile to improve the bonding characteristics of the print, though in many cases this step may not be necessary and/or desired.

In sharp contrast, PE/PE 3D PPOTs can exhibit simultaneous increase of the Young's modulus and tensile strength over the bare textile material, e.g., nonwoven HDPE (e.g., Tyvek) used as the base material in the PE/PE 3D PPOT construction (C), as illustrated in FIG. 8B, as compared to the HDPE/HDPE 3D PPOT comprised of a non-woven HDPE textile layer with an HDPE hexagonal pattern (D). As shown, the curve (D) shows improved tensile strength and the absence of a print failure point. Testing can be performed using a tensile stand or tensile tester 160, as shown in FIG. 8C, while FIG. 8D illustrates an example of an HDPE/HDPE 3D PPOT based on a nonwoven textile 210 with a hexagonal FDM printed pattern 162.

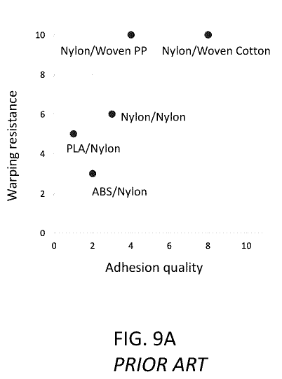

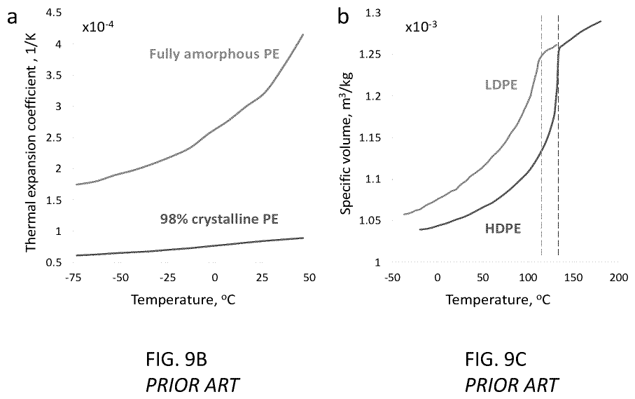

While it will be appreciated that any monomaterial thermoplastic textile/FDM filament combination may yield a recyclable fully-fashioned textile, it does not necessarily provide a strong adhesion between a 3D printed pattern and the substrate 102, which may be important for achieving the material functionality. One example of a poor-quality monomaterial 3D PPOT discussed in prior literature is a nylon/nylon 3D PPOT. As illustrated in FIG. 9A, nylon prints on nylon woven textile can exhibit both poor adhesion and high warping, which are worse than the same qualities evaluated for nylon prints on cotton or polywool woven textiles. One example of a nylon polymer that can exhibit these poor adhesion and high warping properties can include Nylon 645, which is a copolymer of Nylon 6/9, 6 and 6T.

In general, good bonding adhesion can be achieved by using a substrate (i.e., textile) with a surface energy that is approximately 10 dynes/cm greater than the surface tension of the liquid or adhesive, e.g., a molten polymer in the case of FDM 3D printing. The surface energy of solid Nylon 6 at room temperature is 38 dynes/cm, while the surface tension of the molten Nylon 6 at 265 degrees Celsius (20 degrees Celsius above the melting point) is 36 dynes/cm. Generally high surface tension of a liquid is a manifestation of strong intermolecular or interatomic attractive forces. In molten Nylon 6 (polyamide), such interactions between polymer chains in the melt can be the result of strong association between C═O and NH groups. These interactions can prevent reduction of the surface tension in the molten Nylon 6 to the level where it can adhere well to a surface of a textile made from the same polymer.

In contrast, the surface energy of HDPE can decrease from approximately a range of about 35 dynes/cm to about 36 dynes/cm in the solid state at room temperature to approximately a range of about 25 dynes/cm to about 26 dynes/cm at 190 degrees Celsius, which can correspond to the nozzle temperature used in the HDPE/HDPE 3D PPOT printing process 120 of the present embodiments. This can indicate the insignificant effect of the PE chain interactions in the melt and can result in strong bonding observed in HDPE/HDPE 3D PPOT materials. It will be appreciated that similar linear reduction of the surface tension with temperature can occur for smaller molecular weight PE resins (including LDPE and ULMWPE), making them suitable candidates for fabrication of the monomaterial fully-fashioned textiles 110 of the present embodiments. Some additional non-limiting examples of potential polymer candidates for monomaterial 3D PPOTs are Nylon 11 and Nylon 66.

The linear coefficient of thermal expansion of low density polyethylene (LDPE) is approximately 2×10⁻⁴ degrees Celsius⁻¹ at 20 degrees Celsius, and can increase to 3.5×10⁻⁴ degrees Celsius⁻¹ at 80 degrees Celsius. This can be associated with a significant decrease of the density of the molten LDPE relative to a density of solid LDPE (e.g., from about 0.92 g/cm³ at room temperature to about 0.760 g/cm³ at 200 degrees Celsius). HDPE can exhibit an even higher coefficient of thermal expansion in the narrow range of temperatures just around its melting point. A related property is the specific volume expansion, which, for an isotropic material, can equal to the third power of the linear expansion coefficient. Temperature dependence of the thermal expansion coefficient and a specific volume of PE resins with high and low crystallinities based on prior literature data are plotted in FIGS. 9B and 9C, respectively. As shown in FIGS. 9B and 9C, while high-crystallinity PE resins (e.g., HDPE) can exhibit smaller coefficients of thermal expansion than low crystallinity or amorphous resins (e.g., LDPE) around room temperature, high-crystallinity resins (e.g., HDPE) can undergo large thermal expansion at temperatures around their melting point. This can translate into large volumetric changes that can occur during the FDM filament solidification and cooling process, and results in significant warping of HDPE prints. In some embodiments, the coefficient of thermal expansion of the at least one of woven PE fabric, knitted PE fabric, or nonwoven PE fabric, or the one or more PE filaments, can be minimized to approximately a range from about 60 μm/m-° C. to about 150 μm/m-° C.

The textile 110 of the present embodiments can reduce both warping and under-extrusion issues by optimizing the composition of PE filaments by blending several PE resins together and by optimizing the process parameters of FDM printing. For example, a typical blend that enables good FDM print quality can include about 90 wt % medium density polyethylene (MDPE) and about 10 wt % LLDPE, hereinafter referred to as “Blend” for brevity.

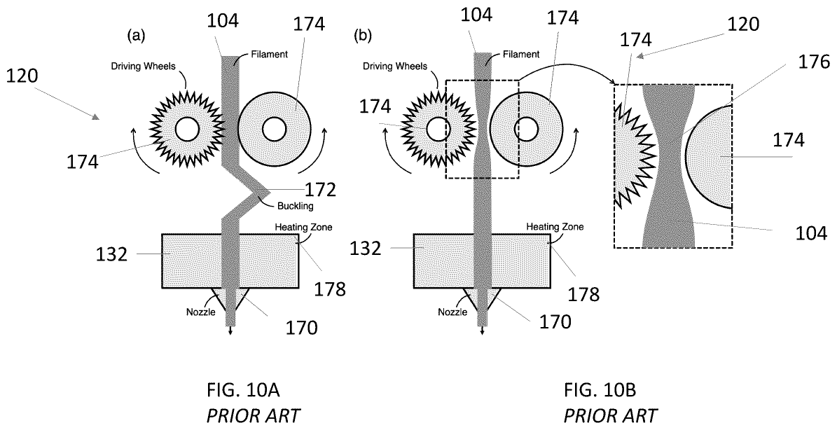

FIGS. 10A and 10B schematically illustrate filament buckling and grinding phenomena stemming from the interplay of material melt viscosity, stiffness, and extrusion rates. For example, material possessing lower stiffness, or high compliance, as shown in FIG. 10A, can be susceptible to buckling 172 due, at least in part, to its flexibility, particularly when it encounters viscosity-induced resistance upon entering the extruder 132. Buckling can occur despite the presence of driving wheels or motors 174 that facilitate progression of the filament 104 toward the extruder. Buckling 172 can disrupt the uniform progression of the filament 104, compromising the steady flow of material through the nozzle 170 and subsequently affecting the extrusion quality, e.g., under-extrusion.

Conversely, materials with greater stiffness, while resisting buckling, may be more prone to grinding 176 when interacting with the drive gears of the extruder 132, especially when confronting resistance due to the effects of viscosity. As shown in FIG. 10B, such an interaction can induce abrasive wear on the filament 104, thereby reducing its diameter. If the diameter decreases excessively, the driving wheels or motors 174 of the extruder 132 can struggle to grip and consistently advance the filament 104, leading to irregular or halted extrusion, e.g. under-extrusion.

In FDM printing, filaments melt within a designated region of the extruder 132, known as the heating zone 178, and melting occurs only after the filament 104 progresses a certain distance within this zone 178. The driving wheels 174, which advance the filament 104, can be situated outside the heating zone 178, as shown, so that any resistance the filament 104 faces due to high melt viscosity can result in deformation between the driving wheels 178 and the point of complete melting in the heating zone 178. The degree of deformation can be contingent, at least in part, on filament softness, with soft filaments exhibiting higher susceptibility to deformation under identical circumstances, and if the deformation is considerable, filament buckling can occur. Thus, even when viscosity and extrusion rates would not lead to grinding in stiffer filaments, sufficiently soft filaments might still buckle, resulting in under-extrusion, as discussed with respect to FIG. 10A above. Stiffer filaments can therefore typically provide a more consistent printing experience, unless they display higher melt viscosity under identical temperature and extrusion rates, as discussed with respect to FIG. 10B above.

The melt viscosity of a molten polymer can be influenced by factors such as temperature and shear rate. The shear rate can be controlled, for example, by the extrusion rate of the FDM process. However, there is only a limited range of suitable extrusion rates, as fast extrusion can lead to filament buckling or grinding even for the type of PE with minimum melt viscosity, while a slow extrusion rate can extend the printing duration, necessitating extensive fabrication times even for small specimens. Thus, one approach can include adjusting the temperature of the nozzle 170 to attain the minimal melt viscosity at the same shear rate and opting for more rigid filaments in FDM printing.

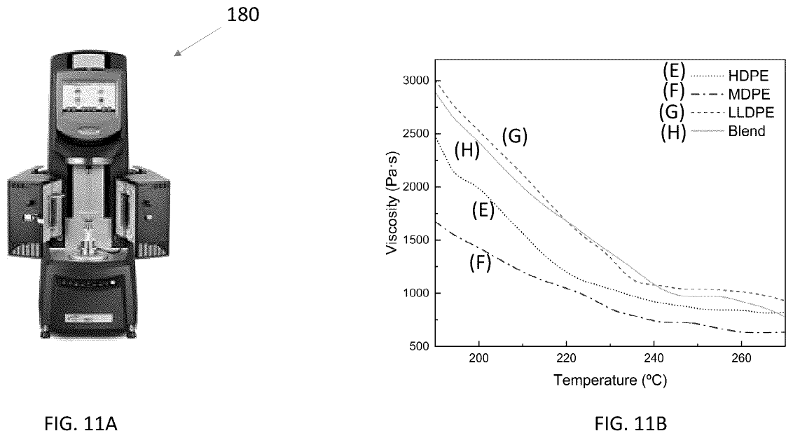

LLDPE filaments can persistently exhibit under-extrusion across temperatures approximately in a range from about 190 degrees Celsius to about 270 degrees Celsius, with filament buckling 172 being a recurrent observation. As such, alternative PE variants with either lower melt viscosity or higher stiffness at similar viscosity levels can be used. For example, the values of dynamic viscosity of HDPE, MDPE, LLDPE, and Blend at different temperatures can be measured using a Discovery Hybrid Rheometer HR-20 180, which is shown in FIG. 11A. A standard stainless steel 8 mm parallel plate geometry can be implemented for these measurements, and the environmental test chamber (ETC) can be used to achieve viscosity measurements up to about 270 degrees Celsius. The maximum temperature of 270 degrees Celsius can be selected, as it is a recognized onset temperature of PE degradation, where the oxidative degradation reactions start to intensify considerably. Pellets of the materials can be loaded onto the geometry within the ETC, and a temperature sweep ranging approximately from about 190 degrees Celsius to about 270 degrees Celsius can be performed at a heating rate of about 5 degrees Celsius and a shear rate of about 1 s 1. Pellets of HDPE, MDPE, and LLDPE can be used directly as procured. Conversely, a person skilled in the art will recognize that the materials used for blends can have undergone blending, extruding, pelletizing, re-extruding, and/or a second pelletizing process to enhance uniformity.

FIG. 11B illustrates the dynamic viscosity of a number of evaluated materials against temperature. As shown, the tested materials, e.g., HDPE (E), MDPE (F), LLDPE (G), and Blend (H) illustrated a negative correlation between melt viscosity and temperature. Escalated temperatures can increase polymer chain mobility, reducing chain entanglements and molecular spacing, leading to an exponential decay in viscosity, which can account for this negative correlation. As shown, LLDPE (G) had the highest melt viscosity across most temperature intervals, followed sequentially by HDPE (H) and MDPE (F) among the pure resins tested. The Blend (H), which can include LLDPE and MDPE, can display a melt viscosity below that of LLDPE below about 220 degrees Celsius and above about 240 degrees Celsius. Material viscosity defines its melt flow index (MFI), and an MFI range for the PE resins and blends that comprise the FDM filaments used to manufacture monomaterial textile 110 of the present embodiments can be approximately in the range of about 1 gram per 10 minutes to about 15 grams per 10 minutes.

For the extrusion performance of each material employed in the viscosity assessments of FIG. 11B, benchmark samples (rectangular prisms measuring about 20 mm by about 20 mm by about 2 mm) were fabricated, except for LLDPE due to its highest melt viscosity and lowest stiffness. Observations indicated that under-extrusion was absent for MDPE (F), HDPE (E), and Blend (H) across the temperature spectrum of about 210 degrees Celsius to about 270 degrees Celsius. Despite some materials having melt viscosities comparable to LLDPE within certain temperature intervals, their higher stiffness can prevent filament buckling and the resulting under-extrusion.

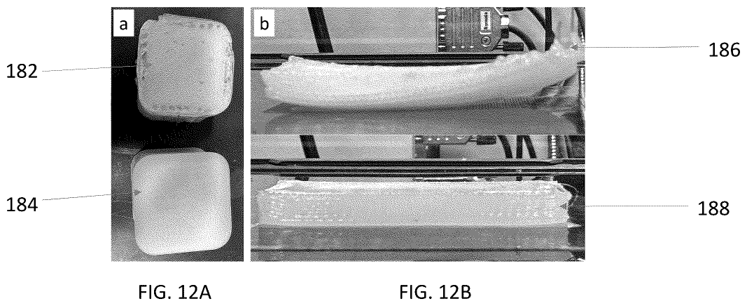

FIGS. 12A-12B illustrate the schematics of the internal stresses in an FDM printed layer that results in under-extrusion and warpage, respectively. For example, 3D printing with PE filaments using optimized parameters to improve print quality can be used to eliminate under-extrusion and warpage in textiles that lack such optimization. A comparison of a sample with under-extrusion 182, e.g., LLDPE, is shown in FIG. 12A as compared to a sample without under-extrusion 184, e.g., Blend. Similarly, a comparison of a sample exhibiting warpage 186, e.g., MDPE, is shown in FIG. 12B, as compared to a sample without warpage 188, e.g., Blend. The degree of warpage, attributed to non-uniform thermal contraction, can be influenced by the temperature difference between the nozzle 170 and the build plate. It will be appreciated that a higher temperature difference generally results in more severe warpage. For printing PE/PE 3D PPOT textiles 110, the temperature of the nozzle 170 can be adjusted to the lowest value where under-extrusion does not occur, owing to the excellent adhesion between the textile 110 and the FDM print. In some embodiments, good quality 3D PPOTs can be achieved with temperatures of the nozzle 170 of about 190 degrees Celsius, providing both the excellent adhesion and no warping. An example of optimum parameters to improve printability and warpage reduction, as well as adhesion improvement, can be found in Table 1 below:

TABLE 1

| Printability & warpage | |
|---|---|
| reduction | Adhesion improvement |
| Printing temperature: | Printing plate/chamber temperature |
| 190-240° C. (for PE/PE 3D | above the glass transition temperature |
| PPOTs); 220-260° C. (for | of the substrate textile polymer (e.g., |
| stand-alone PE accessories) | T_{g}(HDPE) ~−80° C.) |
| Printing speed: | Surface tension of a molten polymer of |
| 25-80 mm/s (for PE/PE 3D | an FDM filament ~10 dynes/cm lower |
| PPOTs); 5-20 mm/s (for | than the surface energy of a textile |
| stand-alone PE accessories) | surface (e.g., 35-36 dynes/cm v. 25-26 |
| Bed temperature: 20-70° C. | dynes/cm for an HDPE/HDPE 3D PPOT) |
| (for PE/PE 3D PPOTs); 40- | Nozzle distance: 0.1-0.3 mm (for PE/PE |
| 70° C. (for stand-alone PE | 3D PPOTs); 0.2-0.4 mm (for stand-alone |
| accessories) | PE accessories) |

The above optimization of the PE/PE 3D PPOT printing process 120 can be very different from a situation when a conventional 3D print needs to be detached from the substrate 102. For example, in some embodiments, PE substrates 102 can provide adhesion that is undesirably strong, making it hard or sometimes impossible to separate them from the complete PE FDM prints, while in some embodiments, PE prints can exhibit very poor adhesion to any other substrate material. As a result, the temperature of the nozzle 170 should be selected as a compromise between reducing warpage and achieving decent adhesion to a printing substrate (and equals, for example, about 260 degrees Celsius for Blend).

### Example

One exemplary embodiment of a workflow for developing mono-PE 3D PPOT swatch prototypes can include a plain weave fabric that is hand-woven on an Ashford 16″ rigid heddle loom with untwisted, multifilament HDPE yarn manufactured at on an industrial Hills filament machine through the melt-spinning process performed at about 230 degrees Celsius. The linear density of the HDPE yarn can be 858 denier. Using a standard clothes iron, indirect heat can be applied to pre-shrink the PE fabric 102. During this pre-shrinking process, a muslin fabric sheet can be laid over the PE fabric 102. Subsequently, an iron set approximately between about 135 degrees Celsius to about 150 degrees Celsius can be moved over the muslin fabric. The pre-shrunk fabric can be secured to the glass bed of an Ultimaker 2+printer using double-sided kapton tape. The printing material, an uncolored, 2.85 mm HDPE filament (Canadian Maker Series), can be extruded at about 195 degrees Celsius. The printer bed 134 can be heated to about 70 degrees Celsius. A variety of different printable structures modeled using Rhino and Grasshopper can be designed for prototyping, demonstrating a number of textile transformations that can be achieved. Further design possibilities of specific relevance to sneaker manufacture can range from the direct printing of a rigid sneaker component, such as eyelets 10 and the heel counter 4, to printing overlays that serve to reinforce the PE fabric 102 while adding an opportunity for aesthetic experimentation. This range of 3D PPOT sneaker design opportunities may be integrated into a one-piece, 3D-printable upper 2, as described with respect to the embodiments above.

Examples of the above-described embodiments can include the following:

1. A method for forming a fully-fashioned polyethylene (PE) polymer textile, the textile comprising at least one of:
one or more PE yarns that form at least one of a woven PE fabric or a knitted PE fabric; or
one or more types of PE resins that form a nonwoven PE fabric, the nonwoven fabric formed by at least one of melt-blowing or spin-bonding,
the method comprising combining the at least one of woven PE fabric, knitted PE fabric, or nonwoven PE fabric with one or more PE filaments in a three-dimensional (“3D”) printing process to fuse the one or more PE filaments into woven, knitted, or nonwoven PE fabric such that the woven, knitted, or nonwoven PE fabric and the 3D printed pattern form a mono-material.

2. The method of example 1, wherein combining the at least one of woven PE fabric, knitted PE fabric, or nonwoven PE fabric with one or more PE filaments in the 3D printing process comprises extruding the one or more PE filament fibers directly onto the at least one of woven PE fabric, knitted PE fabric, or nonwoven PE fabric to form the mono-material.

3. The method of example 1 or 2, further comprising: (a) impregnating the at least one of woven PE fabric, knitted PE fabric, or nonwoven PE fabric via at least one of an initial layer or series of initial layers of melted PE filament into pores of the at least one of woven PE fabric, knitted PE fabric, or nonwoven PE fabric; or (b) partially melting of the at least one of woven PE fabric, knitted PE fabric, or nonwoven PE fabric that is in contact with the one or more PE filament fibers.

4. The method of any of examples 1 to 3, further comprising heat setting the fully-fashioned PE polymer textile via at least one of ironing or high-temperature annealing.

5. The method of any of examples 1 to 4, further comprising one or more of melt-blowing or spin-bonding one or more types of PE resins to form the nonwoven PE fabric.

6. The method of example 5, further comprising:
one or more of weaving or knitting one or more PE yarns to form the at least one of the woven PE fabric or the knitted PE fabric.

7. The method of any of examples 1 to 6, further comprising optimizing at least one of a viscosity or a melt flow index of the at least one of woven PE fabric, knitted PE fabric, or nonwoven PE fabric, or the one or more PE filaments, to prevent one or more of filament buckling, under-extrusion, or nozzle blockage during the 3D printing process.

8. The method of example 7, wherein the viscosity of the at least one of woven PE fabric, knitted PE fabric, or nonwoven PE fabric, or the one or more PE filaments, is optimized to achieve a melt flow index approximately in a range from about 1 gram per 10 minutes to about 15 grams per 10 minutes.

9. The method of any of examples 1 to 8, further comprising minimizing a coefficient of thermal expansion of the at least one of woven PE fabric, knitted PE fabric, or nonwoven PE fabric, or the one or more PE filaments, to reduce warpage of the fully-fashioned PE polymer textile.

10. The method of example 9, wherein the coefficient of thermal expansion of the at least one of woven PE fabric, knitted PE fabric, or nonwoven PE fabric, or the one or more PE filaments, is minimized to approximately a range from about 60 μm/m-° C. to about 150 μm/m-° C.

11. The method of any of examples 1 to 10, wherein the 3D printing process is an FDM printing process.

12. The method of any of examples 1 to 11, wherein the at least one of woven PE fabric, knitted PE fabric, or nonwoven PE fabric, or the one or more PE filaments is composed of blends of different densities of polyethylene.

13. The method of any of examples 1 to 12, further comprising setting a temperature of a printing bed of the 3D printing process to a setpoint above a glass transition temperature of the fully-fashioned PE polymer textile.

14. The method of any of examples 1 to 13, further comprising setting a printing speed of the 3D printing process to approximately a range of about 10 mm/s to about 80 mm/s.

15. The method of any of examples 1 to 14, further comprising setting a nozzle-to-textile distance of the 3D printing process to approximately a range of about 0.1 mm to about 0.3 mm.

16. The method of any of examples 1 to 15, wherein the fully-fashioned PE polymer textile is substantially free of adhesives between the at least one of woven PE fabric, knitted PE fabric, or nonwoven PE fabric, or the one or more PE filaments.

17. The method of any of examples 1 to 16, further comprising pelletizing the PE polymer textile to form a modified one or more types of PE resins.

18. The method of example 17, further comprising recycling the PE polymer textile by: at least one of chopping or grinding the mono-material into smaller pieces that form a PE recyclate;
melting the PE recyclate; and
re-pelletizing the PE by reintroducing the PE polymer textile to be pelletized to form a second PE polymer textile.

19. The method of example 18, wherein the second PE polymer textile is formed by way of a single recycling step.

20. The method of any of examples 1 to 19, further comprising decreasing a surface energy of a molten PE filament material from approximately a range of about 35 dynes/cm to about 36 dynes/cm in a solid state at approximately room temperature to approximately a range of about 25 dynes/cm to about 26 dynes/cm at about 190 degrees Celsius.

21. A material, comprising:
a polyethylene (PE) polymer textile that includes one or more of: (i) at least one of PE fabric woven or knitted from PE yarn or a melt-blown or spunbonded nonwoven PE textile; and (ii) PE printed pattern; and
a three-dimensionally (3D) printed structure, wherein the 3D printed structure is directly fused into the PE fabric during 3D printing to form a mono-material.

22. The material of example 21, wherein the 3D printed structure is formed by way of fused deposition modeling (FDM) printing.

23. An article of clothing comprising the material of example 21 or 22.

24. The article of clothing of example 23, wherein the article comprises an upper section and a lower section of footwear.

25. A method of manufacturing a textile, comprising:
manufacturing a garment;
adding one or more accessories to the garment, the accessories comprising the material of example 21 or 22.

26. The method of example 25, further comprising:
recycling the garment and the one or more accessories; and
manufacturing a second garment from the recycled garment and the one or more accessories.

27. The method of example 25 or 26, wherein the garment is one or more of a spacesuit, helmet, bulletproof vest, sweat-proof garment, or racing suit.

28. The method of any of examples 25 to 27, wherein the garment comprises an upper section and a lower section of footwear, at least the upper section being produced by extruding melted PE filament on a PE polymer textile during printing using an FDM printer.

One skilled in the art will appreciate further features and advantages of the disclosure based on the above-described embodiments. Accordingly, the disclosure is not to be limited by what has been particularly shown and described, except as indicated by the appended claims. All publications and references cited herein are expressly incorporated herein by reference in their entirety.

What is claimed is:

1. A method for forming a fully-fashioned polyethylene (PE) polymer textile, the textile comprising at least one of:
one or more PE yarns that form at least one of a woven PE fabric or a knitted PE fabric; or
one or more types of PE resins that form a nonwoven PE fabric, the nonwoven fabric formed by at least one of melt-blowing or spin-bonding,
the method comprising combining the at least one of woven PE fabric, knitted PE fabric, or nonwoven PE fabric with one or more PE filaments in a three-dimensional (“3D”) printing process to fuse the one or more PE filaments into woven, knitted, or nonwoven PE fabric such that the woven, knitted, or nonwoven PE fabric and the 3D printed pattern form a mono-material.

2. The method of claim 1, wherein combining the at least one of woven PE fabric, knitted PE fabric, or nonwoven PE fabric with one or more PE filaments in the 3D printing process further comprises extruding the one or more PE filament fibers directly onto the at least one of woven PE fabric, knitted PE fabric, or nonwoven PE fabric to form the mono-material.

3. The method of claim 1, further comprising heat setting the fully-fashioned PE polymer textile via at least one of ironing or high-temperature annealing.

4. The method of claim 1, further comprising one or more of melt-blowing or spin-bonding one or more types of PE resins to form the nonwoven PE fabric.

5. The method of claim 1, further comprising optimizing at least one of a viscosity or a melt flow index of the at least one of woven PE fabric, knitted PE fabric, or nonwoven PE fabric, or the one or more PE filaments, to prevent one or more of filament buckling, under-extrusion, or nozzle blockage during the 3D printing process.

6. The method of claim 5, wherein the viscosity of the at least one of woven PE fabric, knitted PE fabric, or nonwoven PE fabric, or the one or more PE filaments, is optimized to achieve a melt flow index approximately in a range from about 1 gram per 10 minutes to about 15 grams per 10 minutes.

7. The method of claim 1, further comprising minimizing a coefficient of thermal expansion of the at least one of woven PE fabric, knitted PE fabric, or nonwoven PE fabric, or the one or more PE filaments, to reduce warpage of the fully-fashioned PE polymer textile.

8. The method of claim 7, wherein the coefficient of thermal expansion of the at least one of woven PE fabric, knitted PE fabric, or nonwoven PE fabric, or the one or more PE filaments, is minimized to approximately a range from about 60 μm/m-° C. to about 150 μm/m-° C.

9. The method of claim 1, further comprising setting a printing speed of the 3D printing process to approximately a range of about 10 mm/s to about 80 mm/s.

10. The method of claim 1, further comprising setting a nozzle-to-textile distance of the 3D printing process to approximately a range of about 0.1 mm to about 0.3 mm.

11. The method of claim 1, wherein the fully-fashioned PE polymer textile is substantially free of adhesives between the at least one of woven PE fabric, knitted PE fabric, or nonwoven PE fabric, or the one or more PE filaments.

12. The method of claim 1, further comprising pelletizing the PE polymer textile to form a modified one or more types of PE resins.

13. The method of claim 12, further comprising recycling the PE polymer textile by:
at least one of chopping or grinding the mono-material into smaller pieces that form a PE recyclate;
melting the PE recyclate; and
re-pelletizing the PE by reintroducing the PE polymer textile to be pelletized to form a second PE polymer textile.

14. A material, comprising:
a polyethylene (PE) polymer textile that includes one or more of: (i) at least one of PE fabric woven or knitted from PE yarn or a melt-blown or spunbonded nonwoven PE textile; and (ii) PE printed pattern; and
a three-dimensionally (3D) printed structure, wherein the 3D printed structure is directly fused into the PE fabric during 3D printing to form a mono-material.

15. The material of claim 14, wherein the 3D printed structure is formed by way of fused deposition modeling (FDM) printing.

16. An article of clothing comprising the material of claim 14.

17. A method of manufacturing a textile, comprising:
manufacturing a garment;
adding one or more accessories to the garment, the accessories comprising the material of claim 14.

18. The method of claim 17, further comprising:
recycling the garment and the one or more accessories; and
manufacturing a second garment from the recycled garment and the one or more accessories.

19. The method of claim 17, wherein the garment is one or more of a spacesuit, helmet, bulletproof vest, sweat-proof garment, or racing suit.

20. The method of claim 17, wherein the garment comprises an upper section and a lower section of footwear, at least the upper section being produced by extruding melted PE filament on a PE polymer textile during printing using an FDM printer.
